(19) United States
(12) Patent Application Publication
(10) Pub. No.: US 2023/0173507 A1
(43) Pub. Date: Jun. 8, 2023

(54) WESP Collection Electrode Insert Or Extension

(71) Applicant: Durr Systems, Inc., Southfield, MI (US)

(72) Inventors: James Cash, Hackettstown, NJ (US); Keith Pierson, Pulaski, WI (US); Jeffrey Rudolph, Suamico, WI (US)

(21) Appl. No.: 17/921,214

(22) PCT Filed: Feb. 5, 2021
(86) PCT No.: PCT/US2021/016728

§ 371 Date: Oct. 25, 2022

Related U.S. Application Data
(60) Provisional application No. 63/033,374, filed on Jun. 2, 2020.

(51) Int. Cl. B03C 3/49; B03C 3/16; B03C 3/86; B03C 3/70

(52) U.S. Cl. CPC B03C 3/49; B03C 3/16; B03C 3/86; B03C 3/70; B03C 2201/08

(57) ABSTRACT

Method and apparatus for cleaning pollution control equipment, such as particulate removal devices, including wet electrostatic precipitators (WESP). The WESP may include a housing, at least one gas inlet in fluid communication with the housing, a gas outlet spaced from the at least one gas inlet and in fluid communication with the housing, one or more ionizing electrodes in the housing adapted to be connected to a high voltage source, and one or more collection electrodes in the housing. The housing may be in fluid communication with a flushing fluid source, such as a water source. The effective length of the collection electrodes is increased with extensions which add significant surface area to the collection electrodes while minimizing the corresponding height increase.

This application claims priority of U.S. Provisional Application Ser. No. 63/033,374 filed Jun. 2, 2020, the disclosure of which is incorporated herein by reference in its entirety.

### BACKGROUND

Pollution control equipment, such as wet electrostatic precipitators (WESP) are used to remove dust, acid mist and other particulates from water-saturated air and other gases by electrostatic means. For example, particulates and/or mist laden water-saturated air flows in a region of the precipitator between discharge and collecting electrodes, where the particulates and/or mist is electrically charged by corona emitted from the high voltage discharge electrodes. As the water-saturated gas flows further within the precipitator, the charged particulate matter and/or mist is electrostatically attracted to grounded collecting plates or electrodes where it is collected. The accumulated materials are continuous washed off by both an irrigating film of water and periodic flushing to a discharge drain or the like.

Such systems are typically used to remove pollutants from the gas streams exhausting from various industrial sources, such as incinerators, coke ovens, glass furnaces, non-ferrous metallurgical plants, coal-fired generation plants, forest product facilities, food drying plants, wood product manufacturing and petrochemical plants.

In wood product manufacturing in particular, for example, maintenance issues are problematic, particularly due to material build-up on the collectors and on electrodes. Sticky particulates, condensation products, etc. tend to adhere to and accumulate on equipment internals, resulting in deleterious downtime and unnecessary expense in an effort to remove them. This has been seen not only in the manufacture of wood products such as panelboard, for example, but also in the biofuel and other markets. Manual intervention is often necessary to adequately clean the equipment internals from the build-up of contaminants, which is highly undesirable. Dirty WESP tubes and electrodes are thus a persistent wood products industry challenge that degrades performance for all WESP styles and designs.

In almost all existing industrial WESP or dry ESP design, the majority of the particulate collection occurs at the inlet of the precipitator. This is more pronounced as the design efficiency of the precipitator increases. A removal efficiency of 90-98% is a typical range for a single stage WESP in many present applications. Using the standard Deutsch-Anderson equation for estimating WESP performance in this range it can be shown that the first ¼ of WESP removes approximately 49-64% of the particulate and the last ¼ of the WESP removes only 3-9% of the particulate. There are other factors that influence this distribution, but this is a reasonable estimate. Current industry standards use tube lengths in the 7 to 20 foot range, with 12 to 14 feet most common. In order to provide modular and shippable systems, tube length is ideally limited to 10 feet in height, and therefore achieving the equivalent tube height of more than 10 feet in the given space is desirable. In addition, the shorter the tube is, the shorter the emitting electrode is (often a rod or pipe with spikes or discs). Shorter electrodes are mechanically stiffer, creating less oscillation from airflow and are easier to align. Good alignment or centering of electrodes is critical to any electrostatic collector.

It therefore would be desirable to increase the effectiveness of the collection surfaces such as collection electrode tubes in an electrostatic collector, without substantially increasing the height of the collection surfaces (or the collector). One advantage of doing so would be the provision of a modular electrostatic collector unit that is readily shippable without sacrificing particulate collection efficiency.

### SUMMARY

Problems of the prior art have been addressed by the embodiments disclosed herein, which provide an electrostatic collector or precipitator with improved effectiveness of electrode collectors, and a method of removing particulate from a process stream with such an electrostatic collector. In certain embodiments, a wet electrostatic precipitator is disclosed, which includes a housing, at least one gas inlet in fluid communication with the housing, at least one gas outlet or exhaust spaced from the at least one gas inlet and in fluid communication with the housing, one or more ionizing electrodes or current emitters in the housing adapted to be connected to a high voltage source, and one or more collection electrodes in the housing, wherein the one or more ionizing electrodes are spaced from the one or more collection electrodes to effect a corona discharge between them. In certain embodiments, the one or more collection electrodes may include a bundle or array of elongated tubes or cells, which may be, for example, circular, square, rectangular or hexagonal in cross-section, or may be plate type, and one or more collection electrode extensions or surface area enhancing members in electrical communication with at least one respective collection electrode. In some embodiments, the collection electrodes form an array of cells, and the number of collection electrode extensions equals the number of cells in the array. In some embodiments the number of collection electrode extensions may be less than the number of cells in the array. In some embodiments the cells are hexagonal in cross-section and form a honeycomb pattern of repeating, hexagonal collecting zones or cells, and the collection electrode extensions also have a hexagonal cross-section. In certain embodiments, each of the ionizing electrodes is supported from the bottom and extends vertically upwardly into a respective one of the collection electrodes. In various embodiments, a lower high voltage grid or support may be used to support the one or more ionizing electrode masts. This lower high voltage grid may be supported from insulators mounted to the top wall or roof of the WESP using one or more of the ionizing electrodes as a support, or from insulators mounted in the side walls of the WESP located below the collecting electrodes, or from an upper high voltage grid that is in turn supported from insulators mounted in either the top wall (roof) or side wall of the WESP above the collection electrodes.

In certain embodiments, the electrode extensions substantially increase the surface area of the surface available for particulate collection, without substantially increasing the height of the collection electrodes. For example, the electrode extensions can include surface area increasing components, such as a plurality of spaced fins that provide additional particulate collecting surface area without requiring a corresponding increase in vertical height of the collection electrodes. In some embodiments, each collection electrode extension or surface area enhancing member(s) is positioned downstream, in the direction of process gas flow, of a respective collection electrode. In other embodiments, each collection electrode or surface area enhancing member(s) is positioned within at least a portion of the interior volume of a collection electrode, downstream, in the direction of process gas flow, of an ionizing electrode position within an interior volume region of a respective collection electrode. In this embodiment, the surface area enhancing member or members may be attached to the wall or walls of the collection electrode itself.

Thus, certain aspects relate to an electrostatic precipitator, comprising: a housing having an inlet for a gas process stream and an outlet spaced from the inlet for exhausting treated gases, a particulate collection surface comprising one or more collection electrodes positioned within the housing between the inlet and the outlet, one or more ionizing electrodes in the housing, each ionizing electrode being associated with a respective collection electrode, and at least one collection surface extension or surface area enhancing member or members in electrical communication with at least one collection electrode, the collection surface extension comprising. For example, a plurality of spaced fins. In various embodiments, a lower high voltage grid or support may be used to support the one or more ionizing electrode masts. This lower high voltage grid may be supported from insulators mounted to the top wall or roof of the WESP using one or more of the ionizing electrodes as a support, or from insulators mounted in the side walls of the WESP located below the collecting electrodes, or from an upper high voltage grid that is in turn supported from insulators mounted in either the top wall (roof) or side wall of the WESP above the collection electrodes.

In certain embodiments there are a plurality of collection electrodes having a hexagonal cross-section and forming a honeycomb array of hexagonal cells. In certain embodiments, there may be a plurality of collection surface extensions, and each collection surface extension may comprise a hexagonal perimeter. In various embodiments, each collection surface extension may be supported on a respective collection electrode and in electrical communication therewith. In some embodiments, each collection surface extension may comprise an outer wall and an inner wall spaced from said outer wall, and wherein the plurality of spaced fins extend from the outer wall to the inner wall. In some embodiments, the inner wall may be eliminated, and the fins extend from one region of the outer all to another region of the outer wall. In some embodiments, each collection electrode extension may be mechanically supported on a respective collection electrode by one or more supports providing aligned interconnections between the collection electrode and the collection electrode extension. Each such support may be a slotted cylindrical tube. In certain embodiments, each cell has a cell surface area and cell height, each collection surface extension has a collection surface extension surface area and a collection extension surface height, and the collection surface extension surface area may be at least four times greater than the cell surface area for each cell height equivalent height to the collection surface area height. In some embodiments, the collection surface extension surface area may be at least eight times greater than the cell surface area for each cell height equivalent height to the collection surface area height. In some embodiments, the collection surface extension surface area may be as much as 20 times greater than the cell surface area for each cell height equivalent height to the collection surface area height. In certain preferred embodiments the collection surface extension surface area is 8 to 12 times the cell surface area for each cell height equivalent height to the collection surface area height.

In other embodiments, each surface enhancing member or members is positioned internally of a collection electrode. For example, each ionizing electrode may be associated with a respective collection electrode, each collection electrode having an internal volume having a first region occupied by its respective ionizing electrode and at least a second region unoccupied by said ionizing electrode, wherein at least a portion of the second region is occupied by surface area enhancing member or members. The wall or walls of the collection electrode may take the place of the outer wall of the collection surface extension and support the surface enhancing member or members (e.g., fins) in a similar manner as the outer wall of the collection surface extension. Accordingly, the surface enhancing member or members occupy an internal region of the collection surface electrode, downstream, in the direction of process gas flow, of the ionizing electrode that is also positioned in an internal region of the collection electrode.

In its methods aspects, disclosed herein are methods of removing particulate material from a process stream by introducing the process stream into the electrostatic precipitator described above, and causing the particulate material to collect on the collection electrodes and collection extensions.

Thus, certain aspects relate to a method of removing particulates from a process stream, comprising: providing a particulate removal device comprising a housing having at least one ionizing electrode charged by a high voltage source, at least one collection electrode, at least one inlet for said process stream, at least one outlet spaced form said inlet, and at least one collection surface extension or surface area enhancing member in electrical communication with said at least one collection electrode; creating a corona discharge between said at least one ionizing electrode and said at least one collection electrode; introducing the process stream into the inlet whereby the process stream contacts the at least one collection electrode; causing particulates in the process stream to deposit on the collection electrode and collection surface extension or surface area enhancing member(s); and removing the deposited particulates from the collection electrode and collection electrode extension or surface area enhancing member(s).

For a better understanding of the embodiments disclosed herein, reference is made to the accompanying drawings and description forming a part of this disclosure.

### BRIEF DESCRIPTION OF THE DRAWINGS

The embodiments disclosed herein may take form in various components and arrangements of components, and in various process operations and arrangements of process operations. The drawings are only for purposes of illustrating preferred embodiments and are not to be construed as limiting. This disclosure includes the following drawings.

FIG. 1 is a perspective view of a wet electrostatic precipitator in accordance with certain embodiments;

FIG. 2 is a perspective view, partially in cross-section, of a portion of collection electrodes forming a bundle or array of collection cells and including a collection electrode extension or surface area enhancing member(s) in accordance with certain embodiments;

FIG. 3 top perspective view of a collection electrode extension or surface area enhancing member(s) in accordance with certain embodiments;

FIG. 4 is a bottom perspective view of a collection electrode extension or surface area enhancing member(s)in accordance with certain embodiments;

FIG. 5 is a perspective view of a collection electrode extension showing one embodiment of its attachment to a collection electrode or surface area enhancing member(s);

FIG. 6 is a perspective internal view of an upper region of a particulate removal apparatus in accordance with certain embodiments;

FIG. 7 is a perspective internal view of a lower region of a particulate removal apparatus in accordance with certain embodiments;

FIG. 8 is another perspective internal view of a lower region of a particulate removal apparatus in accordance with certain embodiments;

FIG. 9A is a front view of an electrode stabilizer in accordance with certain embodiments; and

FIG. 9B is a perspective view of electrode stabilizers in accordance with certain embodiments.

### DETAILED DESCRIPTION

A more complete understanding of the components, processes and apparatuses disclosed herein can be obtained by reference to the accompanying drawing. The figures are merely schematic representations based on convenience and the ease of demonstrating the present disclosure, and is, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawing, and are not intended to define or limit the scope of the disclosure. In the drawing and the following description below, it is to be understood that like numeric designations refer to components of like function.

The singular forms “a,” “an,” and “the” include plural referents unless the context clearly dictates otherwise.

As used in the specification, various devices and parts may be described as “comprising” other components. The terms “comprise(s),” “include(s),” “having,” “has,” “can,” “contain(s),” and variants thereof, as used herein, are intended to be open-ended transitional phrases, terms, or words that do not preclude the possibility of additional components.

All ranges disclosed herein are inclusive of the recited endpoint and independently combinable (for example, the range of “from 2 inches to 10 inches” is inclusive of the endpoints, 2 inches and 10 inches, and all the intermediate values).

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.”

It should be noted that many of the terms used herein are relative terms. For example, the terms “upper” and “lower” are relative to each other in location, i.e. an upper component is located at a higher elevation than a lower component, and should not be construed as requiring a particular orientation or location of the structure. As a further example, the terms “interior”, “exterior”, “inward”, and “outward” are relative to a center, and should not be construed as requiring a particular orientation or location of the structure.

The terms “top” and “bottom” are relative to an absolute reference, i.e. the surface of the earth. Put another way, a top location is always located at a higher elevation than a bottom location, toward the surface of the earth.

The terms “horizontal” and “vertical” are used to indicate direction relative to an absolute reference, i.e. ground level. However, these terms should not be construed to require structures to be absolutely parallel or absolutely perpendicular to each other.

Embodiments disclosed herein include apparatus for removing particulate matter from a process stream containing particulate matter, and may include a mist-generating member that mixes a gas stream entering the apparatus with liquid droplets; one or more ionizing electrodes that electrically charge the particulate matter and the liquid droplets; one or more collecting surfaces such as one or more collection electrodes or surface area enhancing member(s) that attracts and enables removal of electrically-charged particulate matter and intermixed liquid droplets from the gas stream; and a source of washing fluid. In certain embodiments, the one or more collecting surfaces include one or more elongated tubes or cells. In some embodiments, the tubes or cells are hexagonal in cross-section. In other embodiments, the tubes or cells are circular, rectangular or other polygonal shape in cross-section. Preferably the tubes or cells are hexagonal in cross-section, are repeating, and are configured in a bundle to form a honeycomb array. In some embodiments, each cell 30A has a diameter of 16 inches and is 10 feet in length. Preferably each cell 30A is the same size. A honeycomb arrangement is efficient in minimizes wasted space; a hexagonal structure uses the least material to create a lattice of cells within a given volume. The cells employed in the electrostatic precipitator may be constructed of any convenient construction material consistent with their function, including carbon steel, stainless steel, corrosion- and temperature-resistant alloys, lead and fiberglass reinforced plastics. In certain embodiments, the cells are at ground potential during operation of the unit. The one or more ionizing electrodes may also provide collecting surfaces.

In certain embodiments, the WESP unit 100 is an upflow design, which eliminates the need for demisting at the outlet, allows for liquid and solid contaminants to collect by gravity before they reach (and potentially contaminate) the collection electrodes, and enables a simplified layout if exhausting directly to a stack. However, other designs may be used, including downflow designs.

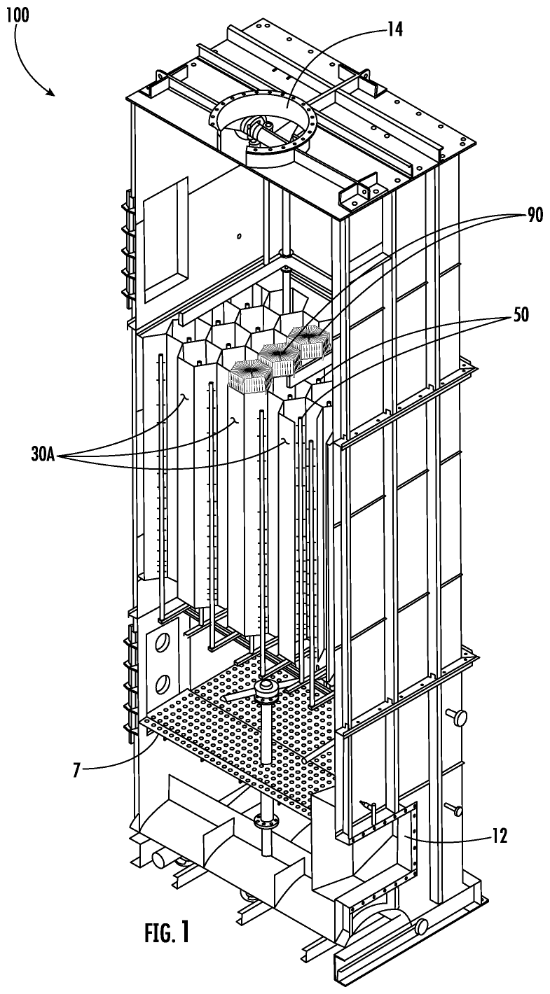

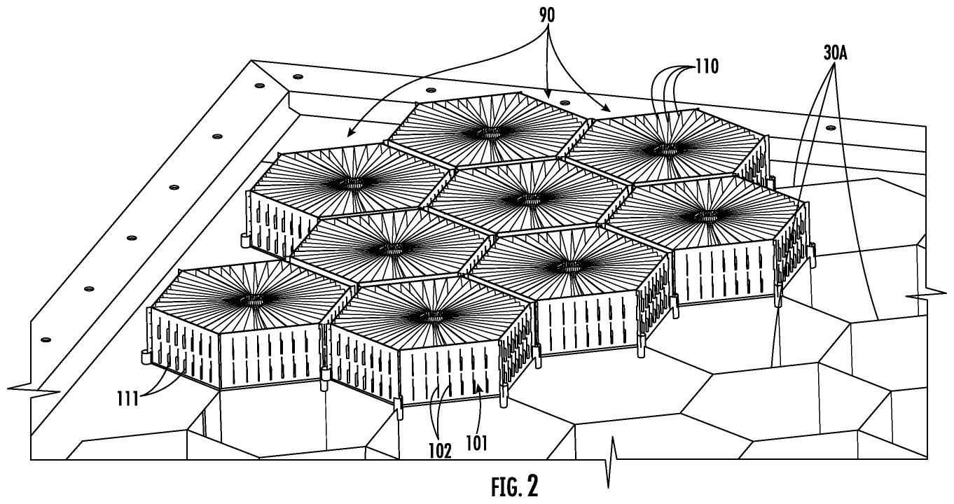

Referring now to FIGS. 1 and 2, an exemplary WESP unit 100 is shown and is an upflow design having a vertical orientation. One advantage of an upflow device is that any water droplets present are carried upward by the airflow, and eventually caused to collect on the collecting surfaces. As a result, the upflow device functions as a demister, preventing any droplets from becoming entrained in the gas flow that exits the device.

In some embodiments, the unit 100 has a lower inlet 12 and an upper outlet or exhaust 14 spaced from the lower inlet 12. The lower inlet 12 may be in fluid communication with suitable ducting or the like to direct process gas in a generally upward flow to be treated by the unit 100 towards collection surfaces that in the embodiment shown include an array 30 of a plurality of cells 30A (FIG. 2). Preferably the cells 30A are hexagonal in cross-section. The array 30 of cells 30A is provided in the unit 100 in a region between the inlet 12 and the outlet 14. The array 30 of cells 30A can be supported in the unit 100 by any suitable means, such as from the side and/or the bottom by supporting the outer perimeter of the array 30 with the use of angle irons or similar supports. In certain embodiments, the array 30 may be formed by coupling individual plates or walls in the desired shape such as by welding. As can be seen in the embodiment of FIG. 1, adjacent cells 30A share common walls.

In certain embodiments, the volume of each cell 30A defined by its outer wall or walls is empty (i.e., devoid of structural material) except for a mast 50. In some embodiments, the furthermost downstream region of the volume of one or more cells 30A, in the direction of process gas flow (e.g., the region near the free end of the cell 30A closest to the outlet 14 of the unit 100), is occupied by one or more surface enhancing members. In some embodiments, that portion of volume is a volume of the cell 30A that is not occupied by a mast 50. In some embodiments each mast 50 can be pre-aligned prior to assembly into the unit 100. The masts 50 when positioned within each cell 30A maintain the array 30 of cells 30A at a desired voltage. In certain embodiments, the potential difference between the masts 50 and the collection surfaces is sufficient to cause current flow by corona discharge, which causes charging of the particulate entrained in the process stream.

In certain embodiments, water can be periodically introduced into the unit and applied to the array 30 of cells 30A to dislodge particular matter that has collected on the collection surfaces. A gas distribution device, such as a perforated plate 7, may be provided to help distribute the process gas evenly through the cells 30A, with similar residence times in each.

In certain embodiments, the effective length of one or more collection surfaces such as cells 30A in the array 30 of cells 30A may be increased by providing one or more high area grounded trap collection surface extensions or surface enhancing members 90, as can be seen for example in FIGS. 1-4. The extensions 90 add effective surface area to the collection surfaces with a compact design, e.g., without a corresponding significant increase in vertical height of the cells 30A. The added area at the outlet of the WESP is in an area where the least amount of particulate needs to be removed, so the smaller gaps between the collecting plates, e.g., 0.125 to 2.0 inches, are not any more prone to plugging than the normal gaps at the entrance to the collecting tube where particulate removal is much higher. In some embodiments, the majority of the additive surface area provided by the extension(s) 90 is in the horizontal direction, rather than the vertical direction; that is, the vertical component of the surface extension member is minimized relative to its horizontal component when in the unit 100. Per given height of each extension 90, the surface area of each extension 90 is substantially greater than the corresponding surface area of the same height of a cell 30A.

FIG. 2 illustrates one embodiment of an extension 90 associated with one cell 30A of the array 30. In the embodiment shown, the extension 90 has a hexagonal perimeter matching the top hexagonal perimeter of the cell 30A, and is in electrical communication with the cell 30A. In some embodiments, the extension 90 is supported on the cell 30A. In certain embodiments, each extension is located at or near the downstream end of the array 30 of cells 30A, e.g., downstream, in the direction of process gas flow from the inlet 12 towards the outlet 14 of the unit 100, of the region where the majority of the particulate has already been collected on the collection surfaces of the cells 30A. In other embodiments, the extension or surface area enhancing member 90 is located within the internal volume of a cell 30A, in a downstream region of the cell 30A (in the direction of process gas flow), e.g., a region downstream of the mast 50 positioned in that cell 30A.

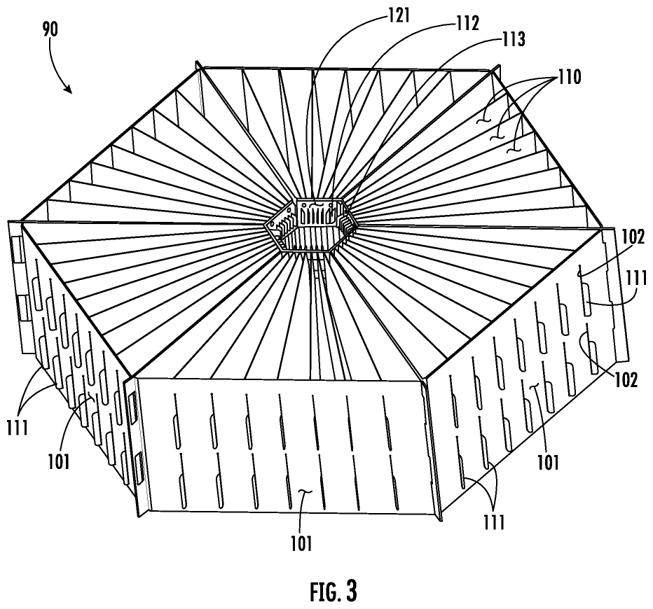

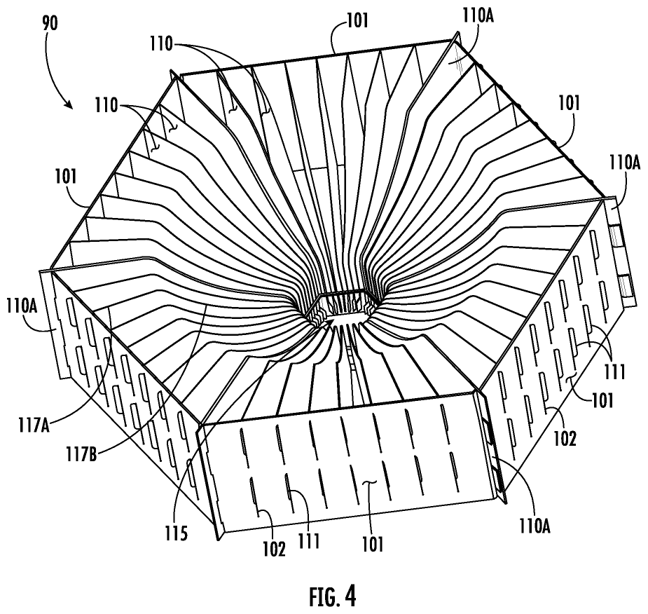

As seen in FIGS. 3 and 4, each extension 90 may include a plurality of connected outer walls which may be one or more outer slotted plates 101 defining the outer perimeter of the extension 90. The outer slotted plate or plates 101 may be arranged in a configuration matching the cross-sectional configuration of a cell 30A. In the embodiment shown, that configuration of the array 30 is honeycomb formed by hexagonal units, and thus six outer slotted plates 101 are provided for the extension 90. Alternatively, fewer than six plates, including a single plate, could be formed into the appropriate configuration rather than using multiple plates to form the perimeter of the extension 90. In certain embodiments, the extension 90 also includes a plurality of surface area increasing components such as fins 110, each fin 110 extending from the outer slotted plate or plates radially inwardly towards the center region 115 of the extension 90. In the embodiment shown, each fin 110 has one or more end tabs 111 that facilitate attachment of the fin 110 to an outer slotted plate 101 by penetrating through a slot 102 in the plate, preferably two vertically spaced and aligned slots 102. Other ways to attach each fin to the plate may be used, in which case the plates may not need to be slotted and the fins may not require end tabs. Accordingly, unlike the volume of a cell 30A which is unoccupied except for a mast 50 positioned therein, the volume of an extension is occupied by surface area increasing components such as fins 110.

In an embodiment where the surface area enhancing member or members 90 are positioned within the internal volume of a cell 30A, the wall or walls of the cell 30A itself may be used to support the surface area increasing components or fins 110, such as in the same manner as the outer slotted plates 101.

In some embodiments, the center region 115 of the extension 90 is defined by one or more inner walls which may be inner slotted plates 121, which delimit the region 115 which is devoid of fins 110. The region 115 devoid of fins 110 may be advantageously positioned at the center of the extension 90 to facilitate drainage of water downward in the WESP, which may help rid the collection surfaces of the cell 30A to which the extension is associated of debris. In other embodiments, the region 115 can be eliminated, with the fins 110 extending through the diameter of the extension 90.

In some embodiments, each fin 110 has one or more end tabs 112 that facilitate attachment of the fin 110 to an inner slotted plate 121 by penetrating through a slot 113 in the plate 121, preferably two vertically spaced and aligned slots 113. Other ways to attach each fin 110 to the inner slotted plate 121 may be used, in which case the inner slotted plates may not need to be slotted and the fins may not require end tabs. The fins 110 thus extend radially from the outer slotted plates 101 to the inner slotted plates 121 as shown, and provide surface area for collection of particulates. In certain embodiments, the length of each fin 110 (e.g., from outer slotted plate 101 to inner slotted plate 121) is more than one times the height of the fin 110, preferably 2 or more times the height of each fin 110. In some embodiments, the surface area of an extension 90 is greater than eight times the surface area of the equivalent cell 30A height. An advantage of the extensions 90 is the reduction of the migration distance for particulate to travel until it contacts a collection surface, such as a reduction to less than ⅛ of the distance particulate must travel to contact a surface in a cell 30A.

In certain embodiments, the fins 110 are equally spaced. In certain embodiments, the spacing between fins 110 is such that there are no gaps greater than about 2 inches. In certain embodiments, the spacing between fins 110 is 0.125 to 1.0 inches. In some embodiments, the fins 110, when assembled in the extension 90, define a substantially flat or planar top surface as seen in FIG. 3. This substantially flat or planar top surface provides a walking surface for maintenance personal to maintain the upper plenum, for example. As see in FIG. 4, in some embodiments each fin 110 has a curvilinear bottom edge. The curvilinear bottom edge has a first generally straight region 117A, followed by a sloping generally parabolically shaped region 117B that terminates at an inner slotted plate 111. The curvilinear bottom is designed such that the extension bottom and the top of the electrode mast mounted in cell 30 maintain a constant distance. This distance should be no closer than the gap between the current emitters on the mast 50 and cell 30 walls and no greater than 125% of this gap, preferably less than 110% of this gap. Maintaining the gap in this range will prevent a short circuit of the electrical field while maintaining an electrical field strength at the bottom of the extension similar to field strength that exists in cell 30 below. Maintaining the electric field strength at the inlet of the extension gives particles the greatest chance of getting collected in the smaller gaps of the collecting electrode extension. Those skilled in the art will appreciate that each fin 110 may have a different shape without departing from the spirit and scope of the embodiments disclosed herein; a key objective of the extension 90 being to provide additional surface area for particulate collection, particularly without adding significantly to the height of the collection surfaces. The extensions 90 do not inhibit airflow to any significant extent, e.g., they cause less than 0.1 inches H₂O) of pressure drop, yet provide particulate collection efficiency of at least about 30 to about 80%, preferably at least about 40%, of the equivalent cell 30A surface area.

In certain embodiments the ionizing electrode mast 50, could extend through the extension 90. In this embodiment the mast would need to be covered in an insulating material such as ceramic where it passes through the extension to prevent an electrical short circuit. This is not a preferred embodiment because a conducting material, most notably water, could deposit on the outside of the insulating material and provide an electrical path between the ionizing electrode mast 50 and the extension 90 causing an electrical short circuit.

Other ways to increase the effective surface area of the collection surfaces without substantially increasing their height, such as by similarly attaching fins or other members to the ends of one or more cells 30A (or internally of one or more cells (30A) in a different configuration, e.g., concentric circles or hexagons, are contemplated and within the scope of the embodiments disclosed herein.

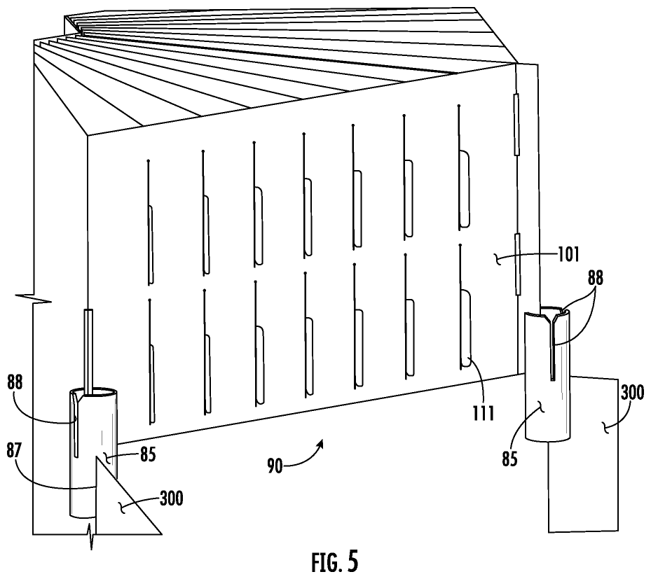

FIG. 5 illustrates an embodiment of supporting an extension 90 on a cell 30A. In the embodiment shown, each extension 90 is mechanically attached to a cell 30A by aligned interconnections, which facilitates their removability from the cell 30A for cleaning or maintenance, for example, without damaging the extension 90 or the cell 30A and thereby allowing the extension 90 to be reused or replaced when maintenance and/or cleaning is completed. These interconnections may be provided by cylindrical posts 85 that have three bottom slots 87 (one shown), each of which accommodates the free end of a top wall 300 of a cell 30A at a Y-shaped intersection point of a honeycomb array. In the embodiment of cells 30A, the slots 87 are separated by 120°. Similarly, cylindrical posts 85 have three top slots 88, each of which accommodates a fin 110 that extends radially beyond the outer slotted plate 101 such as at a bend or junction between two outer slotted plates 101 (e.g., fins 110A in FIG. 4). When assembled, the cylindrical posts 85 thus support the extension 90 on the cell 30A. In certain embodiments, the cylindrical posts 85 can be placed at all six corners of each extension 90 for full support on each respective cell 30A. Other means of supporting the extensions 90 on the cells 30A may be used and are within the scope of the embodiments disclosed herein. Preferably the supports are constructed to facilitate easy removability and replacement of the extensions 90, such as to facilitate cleaning of the collection electrodes.

In certain embodiments the extensions 90 could be mounted and in electrical communication with bottom of collecting electrodes. Such an arrangement may be preferred if the process flow through the WESP was downflow. This is not a preferred embodiment in applications with high particulate loading because all of collected particulate would need to be washed through the extension and the smaller gaps in the extensions could potential plug and require manual cleaning.

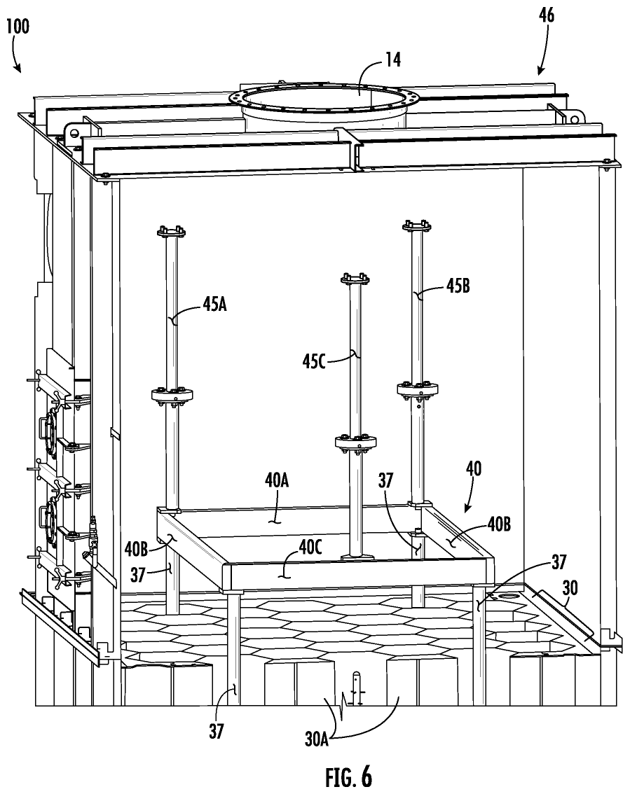

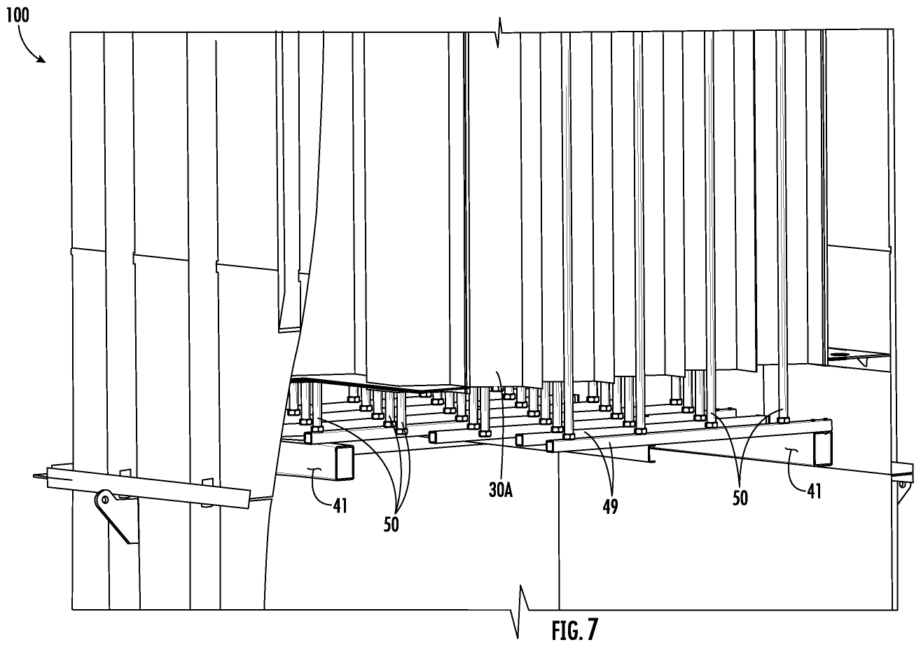

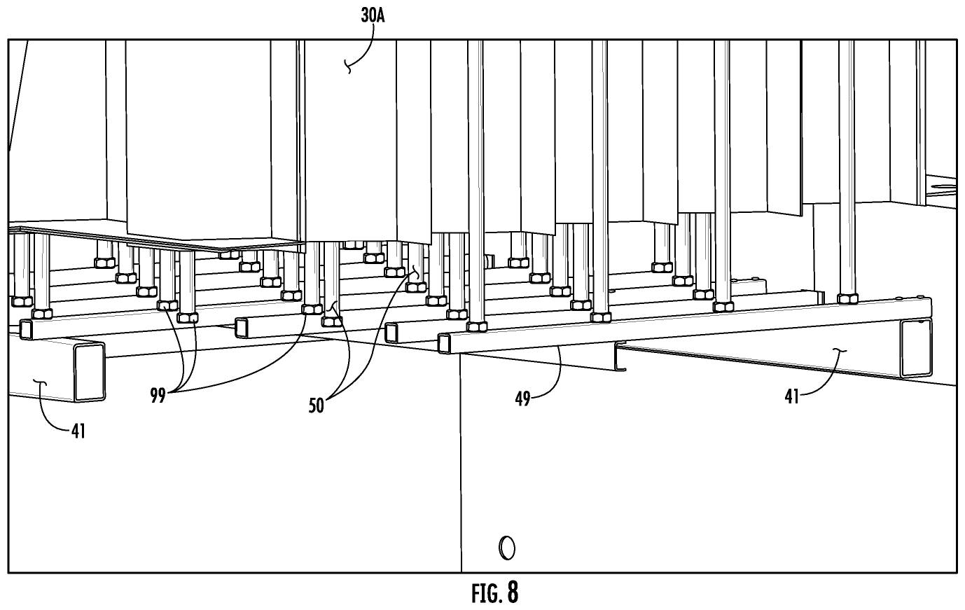

Turning now to FIGS. 6, 7 and 8, in some embodiments, an upper or downstream (in the direction of process gas flow from the inlet 12 to the exhaust 14) high voltage frame 40 (FIG. 6) and a lower or upstream (in the direction of process gas flow from the inlet 12 to the exhaust 14) high voltage frame 41 (FIGS. 7 and 8) are provided and are suspended from the roof or top wall 46 of the unit 100 with suitable supports including one or more support rods (three shown as 45A, 45B and 45C). In certain embodiments, the upper high voltage frame 40 may include four connected support members 40A, 40B, 40C, 40D that form rectangular upper high voltage frame 40 as shown. The top wall 46 of the unit 100 may be electrically insulated from the support rods 45A, 45B, 45C with respective insulators (not shown), which may be housed in respective insulator compartments. In various embodiments, the lower high voltage frame 41 may be supported from the top wall 46 such as via top wall-mounted insulators, or may be supported from side wall-mounted insulators.

In certain embodiments, the lower high voltage frame 41 is supported from the high voltage frame 40 by one or more support electrodes 37, preferably four. By providing the lower high voltage frame 41 in this way, the collection surface extensions 90 can be easily accommodated in the unit 100.

The support electrodes 37 may support a plurality of rigid electrode support beams 49 (FIG. 7), which in turn support the ionizing electrodes or masts 50. In certain embodiments, the rigid electrode support beams 49 are spaced and positioned in a parallel horizontal array, each respectively supporting a plurality of masts 50. Each of the plurality of masts 50 may be generally elongated and rod-shaped and extends upwardly into a respective cell 30A, and is preferably positioned in the center of each cell 30A and is coaxial therewith. Since in this embodiment the masts 50 are supported from the bottom by the plurality of rigid electrode support beams 49, their free ends are downstream, in the direction of process gas flow form the inlet to the outlet, of their supported ends. Preferably the masts 50 are relatively short (e.g., less than 12 feet long, e.g., 10-12 feet long) to minimize deflection. To further minimize deflection, the walls of the masts 50 may be thicker than conventional, e.g., 0.083 inches thick. Further still, cross-bracing may be used to prevent sway of the support structure, e.g., insulated rods or struts connecting the upper high voltage frame 40 and/or lower high voltage frame 41 to a wall of the WESP. In certain embodiments, the volume of each cell 30A defined by its outer wall or walls is empty except for a mast 50. As can be seen in FIGS. 7 and 8, in some embodiments each of the masts 50 is attached to a rigid electrode support beam 49 with a single bolt or other fastener 99, and each mast 50 can be pre-aligned prior to assembly into the unit 100. In some embodiments, suitable position adjusters can be provided on the masts 50 or support beams 49 to properly position them in the unit 100.

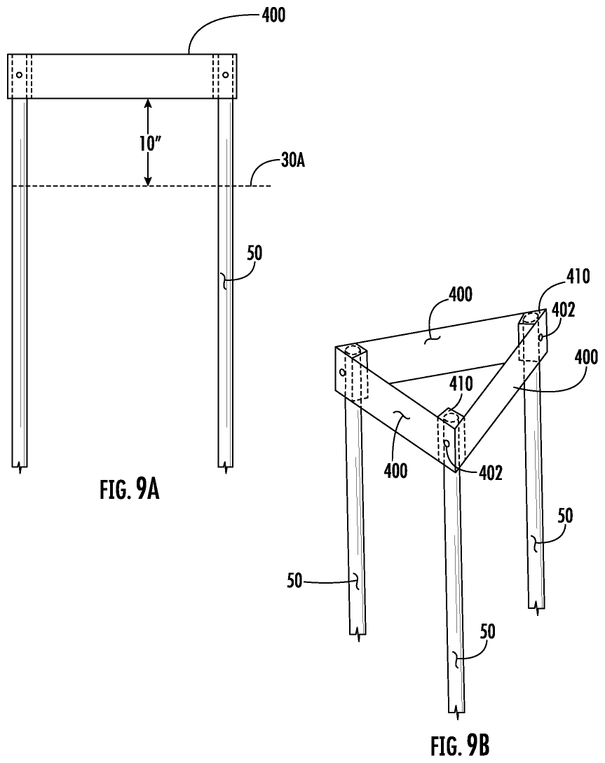

In certain embodiments, as shown in FIGS. 9A and 9B, the top of the masts 50 can extend past the top of the collecting electrodes or cells 30A. In this embodiment, two or more masts 50, preferably at least three, can then be connected at a height far enough above the collection electrode to prevent an electrical short circuit, to stabilize the masts 50. This height should be a minimum of 110% and preferably greater than 125% of the distance between the mast 50 and the collection electrode. In some embodiments, that height is about ten inches. In some embodiments, a stabilizer assembly includes a plurality of straps or plates 400 (three shown) that are coupled to the upper end of masts 50, such as with a roll pin that locks the mast 50 in place (FIG. 9B). An aperture 402 can be formed in each plate 400 to receive the roll pin. In one embodiment, each plate 400 is a 14 gauge metal plate about 3 inches in height. Top plates 410 may be attached to the plates 400 to prevent the masts 50 from vertical movement.

In certain embodiments, during operation of the precipitator 100, a particulate-laden process stream is introduced into the inlet or inlets 12 of the unit and is directed upwardly towards the outlet or outlets 14. A corona discharge is effected between ionizing electrodes or masts 50 and the collection electrodes such as the array 30 of cells 30A, which causes charged particulate in the gas stream to deposit on the collection surfaces. Accumulated particulate deposits can then be removed such as by washing with a water spray.

While various aspects and embodiments have been disclosed herein, other aspects, embodiments, modifications and alterations will be apparent to those skilled in the art upon reading and understanding the preceding detailed description. The various aspects and embodiments disclosed herein are for purposes of illustration and are not intended to be limiting. It is intended that the present disclosure be construed as including all such aspects, embodiments, modifications and alterations insofar as they come within the scope of the appended claims or the equivalents thereof.

What is claimed is:

1. An electrostatic precipitator, comprising: a housing having an inlet for a gas process stream and an outlet spaced from said inlet for exhausting treated gases, a particulate collection surface comprising one or more collection electrodes positioned within said housing between said inlet and said outlet, one or more ionizing electrodes in said housing, each ionizing electrode being associated with a respective collection electrode, and at least one collection surface extension in electrical communication with a collection electrode, said collection surface extension comprising a plurality of spaced fins.

2. The electrostatic precipitator of claim 1, wherein there are a plurality of collection electrodes having a hexagonal cross-section and forming a honeycomb array of hexagonal cells.

3. The electrostatic precipitator of claim 2, wherein there are a plurality of collection surface extensions, each collection surface extension comprising a hexagonal perimeter and being supported on a respective collection electrode.

4. The electrostatic precipitator of claim 3, wherein each collection surface extension comprises an outer wall and an inner wall spaced from said outer wall, and wherein said plurality of spaced fins extend from said outer wall to said inner wall.

5. The electrostatic precipitator of claim 3, wherein each collection electrode extension is mechanically supported on a respective collection electrode by one or more supports providing aligned interconnections between said collection electrode and said collection electrode extension.

6. The electrostatic precipitator of claim 5, wherein each support is a slotted cylindrical tube.

7. An electrostatic precipitator, comprising: a housing having an inlet for a gas process stream and an outlet spaced from said inlet for exhausting treated gases, a particulate collection surface comprising one or more collection electrodes positioned within said housing between said inlet and said outlet, one or more ionizing electrodes in said housing, each ionizing electrode being associated with a respective collection electrode, and at least one collection surface extension in electrical communication with a collection electrode, wherein each collection electrode comprises a cell having a cell surface area and a cell height, each collection surface extension having a collection surface extension surface area and a collection extension surface height, and wherein said collection surface extension surface area is at least four times greater than said cell surface area for each said cell height equivalent height to said collection surface area height.

8. The electrostatic precipitator of claim 7, wherein there are a plurality of collection electrodes having a hexagonal cross-section and forming a honeycomb array of hexagonal cells.

9. The electrostatic precipitator of claim 8, wherein there are a plurality of collection surface extensions, each collection surface extension comprising a hexagonal perimeter and being in electrical communication with a respective collection electrode.

10. The electrostatic precipitator of claim 9, wherein each collection surface extension comprises an outer wall and an inner wall spaced from said outer wall, and wherein said plurality of spaced fins extend from said outer wall to said inner wall.

11. A method of removing particulates from a process stream, comprising:
providing a particulate removal device comprising a housing having at least one ionizing electrode charged by a high voltage source, at least one collection electrode, at least one inlet for said process stream, at least one outlet spaced form said inlet, and at least one collection surface extension in electrical communication with said at least one collection electrode;
creating a corona discharge between said at least one ionizing electrode and said at least one collection electrode;
introducing said process stream into said inlet whereby said process stream contacts said at least one collection electrode;
causing particulates in said process stream to deposit on said collection electrode and collection surface extension; and
removing said deposited particulates from said collection electrode and collection electrode extension.

12. The method of claim 11, wherein there are a plurality of collection electrodes having a hexagonal cross-section and forming a honeycomb array of hexagonal cells.

13. The method of claim 12, wherein there are a plurality of collection surface extensions, each collection surface extension comprising a hexagonal perimeter and being supported on a respective collection electrode.

14. The method of claim 13, wherein each collection surface extension comprises an outer wall and an inner wall spaced from said outer wall, and wherein said plurality of spaced fins extend from said outer wall to said inner wall.

15. The method of claim 13, wherein each collection electrode extension is mechanically supported on a respective collection electrode by one or more supports providing aligned interconnections between said collection electrode and said collection electrode extension.

16. An electrostatic precipitator, comprising: a housing having an inlet for a gas process stream and an outlet spaced from said inlet for exhausting treated gases, a particulate collection surface comprising one or more collection electrodes positioned within said housing between said inlet and said outlet, one or more ionizing electrodes in said housing, each ionizing electrode being associated with a respective collection electrode, an upper high voltage support grid positioned in said housing downstream, in the direction of gas process stream flow from said inlet to said outlet, of said particulate collection surface, and a lower high voltage support grid positioned in said housing upstream, in the direction of gas process stream flow from said inlet to said outlet, of said particulate collection surface, said lower high voltage support grid supporting said one or more ionizing electrodes.

17. The electrostatic precipitator of claim 16, further comprising at least one collection surface extension in electrical communication with a collection electrode, said collection surface extension comprising a plurality of spaced fins.

18. The electrostatic precipitator of claim 16, wherein said housing has a roof, said device further comprising electrical insulators supported from said roof wherein said lower high voltage support grid is connected to and supported by said insulators.

19. The particulate removal device of claim 16, wherein said lower high voltage support grid is connected to and supported by said upper high voltage support grid.

20. The particulate removal device of claim 16, wherein said housing has side walls, and wherein said lower high voltage frame is supported from electrical insulators mounted in insulator compartments on said side walls, below said at least one collecting electrode.

21. An electrostatic precipitator, comprising: a housing having an inlet for a gas process stream and an outlet spaced from said inlet for exhausting treated gases, a particulate collection surface comprising one or more collection electrodes positioned within said housing between said inlet and said outlet, one or more ionizing electrodes in said housing, each ionizing electrode being associated with a respective collection electrode, each collection electrode having an internal volume a first region of which is occupied by its respective ionizing electrode and at least a second region of which is unoccupied by said ionizing electrode, wherein at least a portion of said second region is occupied by one or more surface area enhancing members.

22. The electrostatic precipitator of claim 21, wherein each said portion of said second region occupied by said surface area members is downstream, in the direction of process gas flow during operation of said electrostatic precipitator, of said respective ionizing electrode that occupies said internal volume of said collection electrode.
